(19) United States
(12) Patent Application Publication
(10) Pub. No.: US 2012/0006853 A1
(43) Pub. Date: Jan. 12, 2012

(54) CASE FOR CREAM COSMETICS HAVING AIRLESS PUMP

(75) Inventor: Jun-Kuk Lim, Gyeonggi-do (KR)

(73) Assignee: TOLY KOREA, INC., Gyeonggi-do (KR)

(21) Appl. No.: 12/743,841

(22) PCT Filed: Jul. 23, 2009
(86) PCT No.: PCT/KR2009/004087

§ 371 Date: May 20, 2010

(30) Foreign Application Priority Data
Mar. 31, 2009 (KR) 10-2009-0027218

(51) Int. Cl. G01F 11/00

(52) U.S. Cl. 222/256

(57) ABSTRACT

The invention relates to a case for cream cosmetics having an airless, and more particularly, to a case for cream cosmetics having an airless pump wherein an airless pump is provided to the case storing the cosmetics of a cream state, so that a foreign material or air is basically prevented from being introduced from the outside during the non-use of the cosmetics and the cosmetics are thus prevented from being contaminated and deteriorated and the cosmetics are discharged in a constant amount all the time by operating the pump during the use of the cosmetics, thereby enabling the cosmetics to be used more conveniently and efficiently.

The case for cream cosmetics having an airless pump comprises: a storage case 10 that stores the cream cosmetics in a storage space 11 and has a push plate 12 mounted therein; an airtight cap 20 that is sealingly engaged to an opening of the storage case 10 and has therein a mount space 21 and at one side an exit port 22 communicating with the storage case 10; a nozzle cap 30 that is engaged to the storage case 10 at an upper part of the airtight cap 20 and has at one side a mount space in which a pump is mounted and at the other side a nozzle 31 of a concave recess shape; an airless pump 40 that has a cylinder 41 vertically mounted between the airtight cap 20 and the nozzle cap 30, a suction port 46 having a suction valve 47 is provided to a lower part of the cylinder, a discharge port 49 having a discharge valve 48 is provided to a side of an outer periphery so that the nozzle 31 is connected to a discharge pipe 32, and a piston 44 is provided in the pump to provide pumping force, the piston being moved upward and downward by an operation button 45 and a spring 43; and a cover 50 that is openably engaged to an upper part of the nozzle cap 30.

### CROSS-REFERENCE TO RELATED APPLICATIONS

This application claims all benefits of Korean Patent Application No. 10-2009-0027218 filed on Aug. 6, 2009 in the Korean Intellectual Property Office, the disclosures of which are incorporated herein by reference.

### BACKGROUND OF THE INVENTION

1. Field of the Invention

The invention relates to a case for cream cosmetics having an airless, and more particularly, to a case for cream cosmetics having an airless pump wherein an airless pump is provided to the case storing the cosmetics of a cream state, so that a foreign material or air is basically prevented from being introduced from the outside during the non-use of the cosmetics and the cosmetics are thus prevented from being contaminated and deteriorated and the cosmetics are discharged in a constant amount all the time by operating the pump during the use of the cosmetics, thereby enabling the cosmetics to be used more conveniently and efficiently.

2. Description of the Prior Art

In general, the cosmetics of a gel or cream state (hereinafter, referred to as “cream”) are widely used. The cosmetics are typically stored in a cosmetic case of a tube type or a case for cream cosmetics having a wide opening, which is flat and opened and shut by a cover.

In particular, the cream cosmetics, which are widely used as basic cosmetics, are typically stored in a cosmetic case having a wide opening, which is opened and shut by a cover, so as to conveniently use the cosmetics or to use the cosmetics without waste.

In other words, the case for cream cosmetics comprises a storage case made of glass or synthetic resin, having a wide opening and storing cream cosmetics therein, and a cover for opening and shutting the opening of the storage case in a screw manner. In order to improve the convenience of use, the case is formed to be relatively low.

Thus, when using the cosmetics, the cover is opened and the cream cosmetics stored in the storage case are dipped and used by a finger. After the use, the cover is airtightly shut.

However, the above case for cream cosmetics has only the function of storing the cream cosmetics and is opened and shut by the cover. Thus, when storing the cosmetics, it is difficult to closely seal the case.

In addition, whenever the cosmetics are used, the storage case is opened and exposed to the atmosphere, so that the outside air or foreign substance is introduced to easily contaminate and deteriorate the cosmetics.

In this case, even when the cosmetics are not rapidly contaminated and deteriorated, the inherent scent and smell of the cosmetics as well as the moisture are easily emitted whenever the cosmetics are used. Thus, the peculiar inherent ingredients of the cosmetics are lost.

In addition, according to the above structure, when using the cosmetics, a user uses a necessary amount of the cosmetics by dipping a finger into the cosmetics in the storage case under state in which the cover is opened. Thus, it is difficult to use the accurate amount of cosmetics, so that the cosmetics are wasted. In addition, during the use of the cosmetics, the cosmetics are further contaminated and deteriorated through the finger.

Furthermore, the storage case that stores the cosmetics is formed into a simple shape having the wide opening since the cosmetics are used by the finger. Accordingly, it is difficult to completely use the cosmetics remaining on the corner of the bottom.

### SUMMARY OF THE INVENTION

Accordingly, the present invention has been made to solve the above problems occurring in the prior art.

An object of the invention is to provide a case for cream cosmetics having an airless pump wherein a structure of the case storing the cream cosmetics of gel and cream states is improved, i.e., an airless pump enabling a proper amount of cosmetics to be discharged by a push operation is provided to the case, so that a foreign material or air is basically prevented from being introduced from the outside and the cosmetics are thus prevented from being contaminated and deteriorated and the cosmetics are discharged in a constant amount all the time by operating the pump during the use of the cosmetics, thereby enabling the cosmetics to be conveniently used.

Another object of the invention is to provide a case for cream cosmetics having an airless pump wherein the cosmetics stored in the storage case are completely discharged to reduce the waste of the cosmetics.

In order to achieve the above objects, according to the invention, a separate airless pump is provided to a cosmetic case that stores the cream cosmetics, so that the inside of a storage case is always maintained under vacuum state. Thus, it is possible to block the outside air and foreign substance from being introduced. Further, during the use of the cosmetics, it is possible to discharge the cosmetics in a proper amount by the vacuum pressure and the pumping force of the pump.

According to the invention, there is provided a case for cream cosmetics having an airless pump comprising a storage case that is made of synthetic resin or glass, efficiently stores the cream cosmetics and has therein a push plate having a function of pushing up the cosmetics, an airtight cap and a nozzle cap that are sealingly engaged to an upper opening of the storage case, an airless pump that is mounted between the airtight cap and the nozzle cap and pumps and discharges a predetermined amount of the cosmetics to a nozzle by a push operation of a user, and a cover that opens and shuts an upper part of the nozzle cap.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view showing a structure of a case for cream cosmetics according to an embodiment of the invention;

FIG. 2 is a front view of the invention, in which a cover is omitted;

FIG. 3 is an overall sectional view of the invention;

FIG. 4 is a sectional view showing a state in which a cover is opened in FIG. 3;

FIG. 5 is a sectional view showing a structure of an airless pump of the invention, and

FIGS. 6 and 7 show operation states of the invention.

### DETAILED DESCRIPTION OF THE PREFERRED EMBODIMENTS

Hereinafter, a preferred embodiment of the present invention will be described with reference to the accompanying drawings. In the following description of the present invention, a detailed description of known functions and configurations incorporated herein will be omitted when it may make the subject matter of the present invention rather unclear.

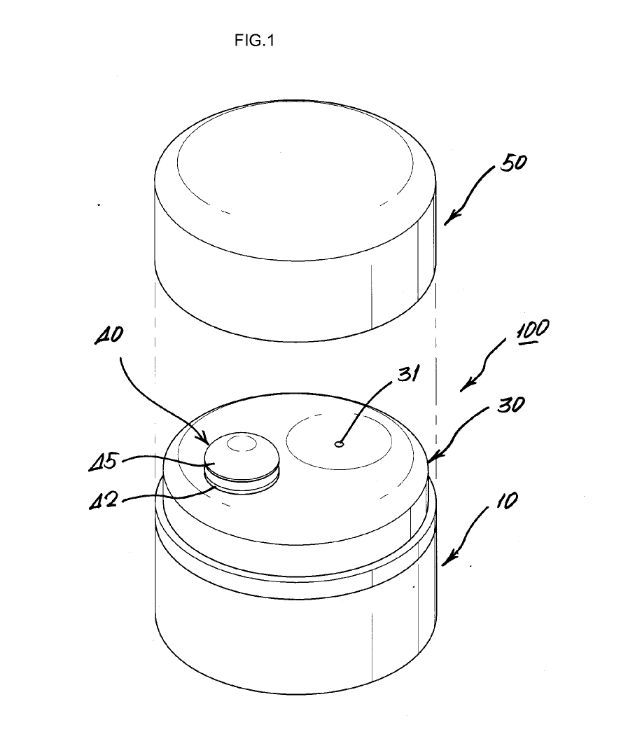

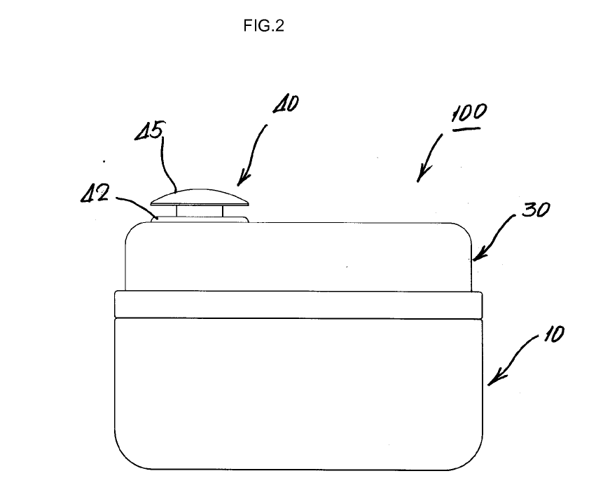

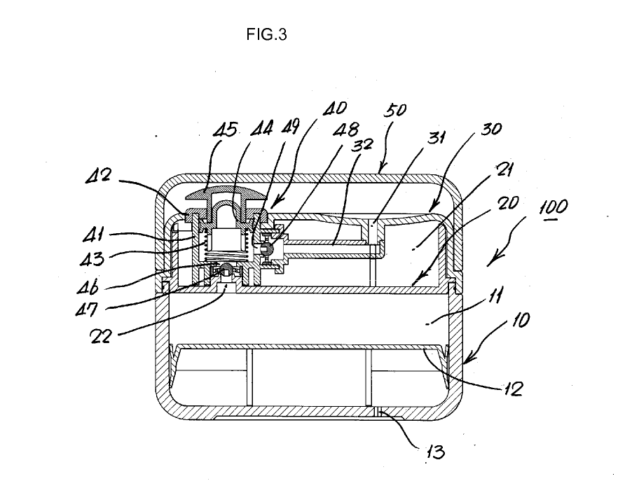

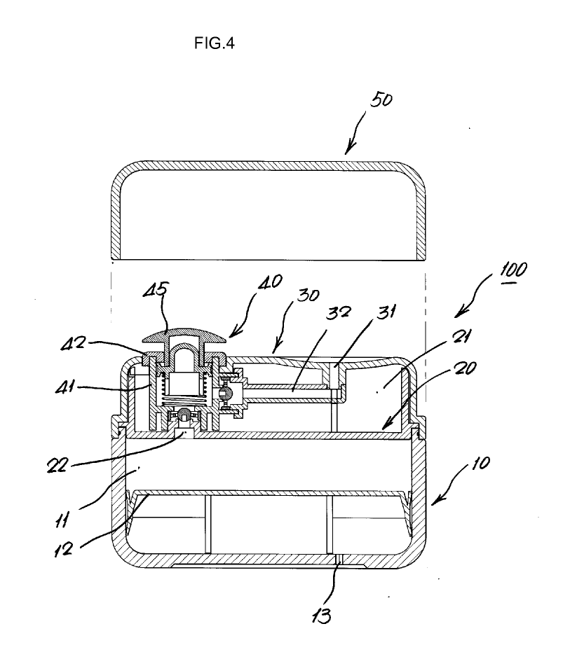

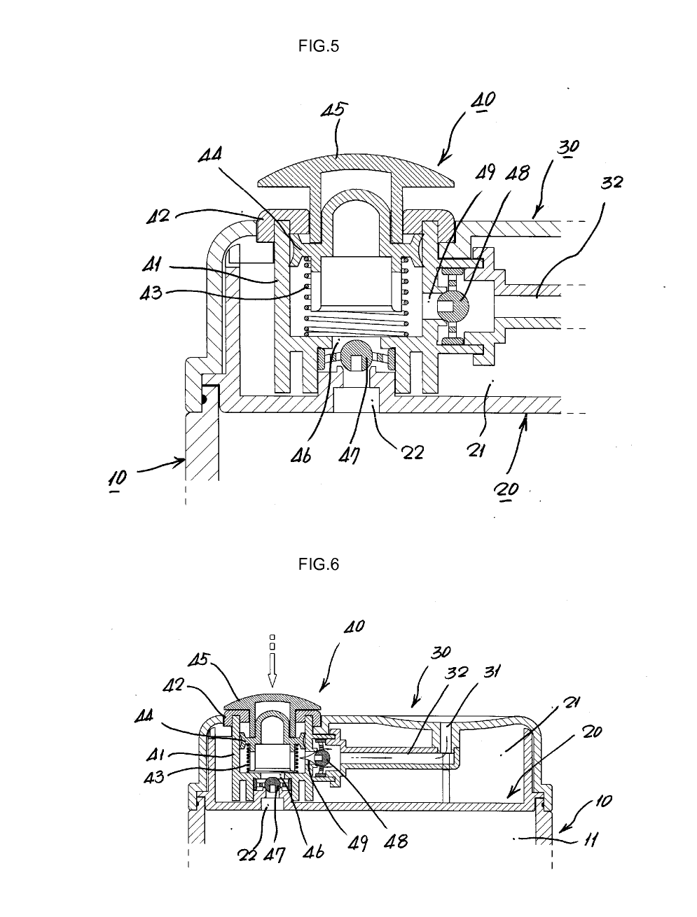

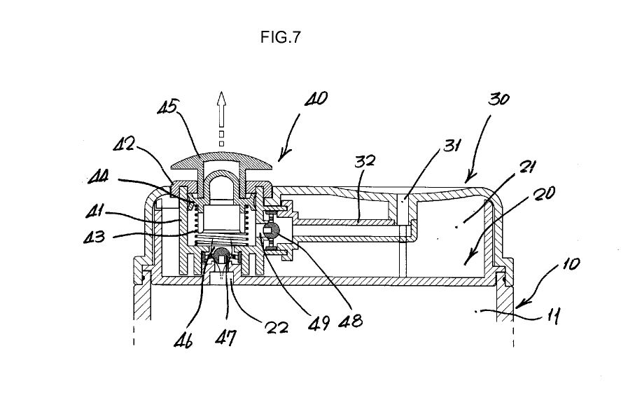

FIGS. 1 and 2 show an overall structure of a case for cream cosmetics to which the invention is applied, FIGS. 3 to 5 are sectional views a case for cream cosmetics according to an embodiment of the invention and FIGS. 6 and 7 show using states a case for cream cosmetics according to an embodiment of the invention. In the drawings, a reference numeral 100 indicates a main body of a case for cream cosmetics according to an embodiment of the invention.

A main body 100 of a case for cream cosmetics according to an embodiment of the invention comprises a storage case 10 that stores cream cosmetics and has a low height, an airtight cap 20 that is engaged to an upper opening of the storage case 10 and seals the storage case, a nozzle cap 30 that is engaged to an upper part of the storage case 10 and has a nozzle at its upper part, an airless pump 40 that is provided between the airtight cap 20 and the nozzle cap 30 and pumps the cosmetics to the nozzle by a push operation, and a cover 50 that is openably provided to the upper part of the nozzle cap 30.

To be more specific, the storage case 10 is made of rigid material such as glass or synthetic resin so as to easily store the cream cosmetics. The storage case has an opening, which is opened at an upper part, and has a push plate 12 in a storage space 11, which enables the stored cosmetics to be discharged to the opening little by little.

The push plate 12 is moved upward by inner vacuum pressure resulting from a pumping operation of the airless pump 40, thereby pushing up the stored cosmetics. The storage case 10 is formed at its bottom with an air passage hole 13 so that the push plate 12 can be smoothly moved upward and downward.

In addition, the airtight cap 20 is engaged to an upper opening of the storage case 10 and seals the storage case. The airtight cap has at its upper part an opening and therein a mount space 21 in which the airless pump 40 is mounted.

Further, one side of the airtight cap 20 is formed with an exit port 22 communicating with the storage case 10, so that the cosmetics stored in the storage case 10 are discharged into the pump as the airless pump 40 is operated.

The airtight cap 20 is provided at its upper part with the nozzle cap 30. The nozzle cap 30 is structured to seal the opening of the airtight cap 20 and is engaged to the upper part of the storage case 10. One side of the nozzle cap is formed with a nozzle 31 that enables the cosmetics, which are pumped through the airless pump 40, to be discharged to the outside and the other side thereof is provided with the airless pump 40.

The nozzle 31 has a concave circular recess at its upper face. A user can easily dip and use the cream cosmetics discharged through the nozzle by a finger.

In addition, the airless pump 40 is provided in the mount space 21 between the airtight cap 20 and the nozzle cap 30 and has a cylinder 41 vertically mounted therebetween.

The cylinder 41 is mounted so that a lower part thereof communicates with the exit port 22 of the airtight cap 20 and an upper part thereof is fixed to the nozzle cap 30 with a fixing element 42. The cylinder has therein a piston 44 that is elastically mounted by a spring 43, and an upper part of the piston is provided with an operation button 45 that is exposed to the outside.

The piston 44 is moved upward and downward in the cylinder 41 by the elastic force of the spring 43 and a push operation of the operation button 45, thereby providing pumping force. A part of the operation button 45 is exposed to the outside, so that a user can push it.

At this time, it is preferable that the upper part of the operation button 45 has a convex shape for easy push operation and is upward protruded as a gap resulting from the upward and downward movements.

In addition, the cylinder 41 is formed at its lower part with a suction port 46 that is connected to the exit port 22 of the airtight cap 20. A separate suction valve 47 is mounted on the suction port 46 to control suction of the cosmetics of the storage case 10 into the cylinder 41.

The suction valve 47 is a check valve that has a ball bearing structure and opens and shuts the exit port 22 of the airtight cap 20 and that that enables the cosmetics in the storage case 10 to flow into the cylinder 41 through the exit port 22 and the suction port 46 and blocks the cosmetics from flowing in a reverse direction.

In addition, a discharge port 49 that is opened and shut by a discharge valve 48 is formed at one side of an outer periphery of the cylinder 41 and a separate discharge pipe 32 connected to the nozzle 31 is mounted to the discharge port 49.

The discharge port 49 is a passage though which the cosmetics compressed in the cylinder 41 are discharged and is provided therein with the discharge valve 49 that enables the cosmetics to be discharged and blocks the reverse introduction of the cosmetics. Further, the discharge port 49 is mounted with the discharge pipe 32, so that it is connected to the nozzle 31.

To be more specific, the suction and discharge valves 47, 48 are alternately operated and shut in accordance with the pumping pressure in the cylinder 41 resulting from the pumping force of the operation button 45. When the operation button 45 is pushed, the piston 44 is moved downward, so that the suction valve 46 is shut and the discharge valve 48 is opened. Thus, the cosmetics are discharged to the nozzle 31 via the discharge port 49 and the discharge pipe 32. To the contrary, when the operation button 45 is moved upward, the discharge valve 48 is shut and the suction valve 47 is opened, so that the cosmetics in the storage case 10 is introduced into the cylinder 41 through the suction port 46.

The cover 50 is opened and shut at the upper part of the nozzle cap 30 and protects the nozzle 31 from the outside together with the pump 40 a part of which is exposed.

Accordingly, the cosmetic case 100 of the invention structured as described above is used as a case for cream cosmetics that stores cream cosmetics, as described above.

As can be seen from the drawings, the airtight cap 20 and the nozzle cap 30 are engaged to the upper opening of the storage case 10. The airless pump 40 is mounted on the discharge passage between the caps, so that the cosmetics in the storage case 10 are stored under vacuum state. The nozzle cap 30 can be opened and shut by the cover 50 separately mounted.

Under such state, the inside of the storage case 10 is completely airtight by the airtight cap 20, the nozzle cap 30 and the airless pump 40, so that it is possible to basically prevent the outside air and foreign substance from being introduced. Thus, it is possible to store the cosmetics for a long time.

When a user intends to use the cosmetics in the cosmetic case 100, the user first opens the cover 50 and pushes the operation button 45 of the pump 40, which is exposed upward. By the resultant pushing force, the piston 44 is moved downward in the cylinder 41 while compressing the spring 43, thereby compressing the inside of the cylinder 41.

Thereby, the suction valve 47 mounted at the suction port 46 of the cylinder 41 is shut and the discharge valve 48 is opened, so that the cosmetics in the cylinder 41 are discharged to the nozzle 31 via the discharge port 49 and the discharge pipe 32.

Thus, the user can easily use the cosmetics discharged to the nozzle 31 with a finger. At this time, since the nozzle 31 is formed into the semi-sphere recess, the cosmetics are not diffused, so that the user can use the cosmetics safely and conveniently.

To the contrary, when the pushed operation button 45 is released, the operation button 45 is moved upward and is returned to its original position by the elastic force of the compressed spring 43. Thus, the vacuum pressure prevails in the cylinder 41, so that the discharge valve 48 is shut and the suction valve 47 is opened. As a result, the cosmetics in the storage case 10 are introduced into the cylinder 41 through the suction valve 46 and stands by for next operation.

At this time, the pumping force of the airless pump 40 that is operated by the operation button 45 is always constant. Accordingly, it is possible to accurately discharge the cosmetics stored in the storage case 10 to the nozzle 31 by a predetermined amount.

By repeating the above operations, it is possible to discharge and use the cosmetics in the storage case 10 by a proper amount. In some cases, after completely using the cosmetics stored in the storage case 10, it is possible to open the airtight cap 20 and the nozzle cap 30 and then to refill the cosmetics, alternatively to store the other cosmetics such as detergents, medical supplies and the like.

In particular, according to the invention, the cream cosmetics in the cosmetic case 100 are forcibly discharged with the airless pump 40. Thus, it is possible to variously design an overall height or area of the cosmetic case 100.

As described above, according to the invention, there is provided the case for cream cosmetics that stores only the cream cosmetics. It is possible to store and use the cosmetics more conveniently.

In other words, since the cream cosmetics can be stored under vacuum state in the storage case, the foreign substance or air is blocked from being introduced from the outside even when the cosmetics are stored for a long time. Thus, it is possible to prevent the cosmetics from being contaminated and deteriorated.

In addition, during the use of the cosmetics, just by pushing the operation button of the airless pump mounted on the cover, it is possible to always discharge a predetermined amount of the cosmetics by the pumping force. Thus, it is possible to conveniently use the cosmetics and to use the cosmetics just by a predetermined amount, thereby reducing the waste of the cosmetics.

In other words, since it is not necessary to dip and use the cosmetics, the convenience of the cosmetics is improved and the cosmetics are prevented from being contaminated and deteriorated. Furthermore, the cosmetics are completely discharged by the vacuum pressure in the storage case, so that it is possible to entirely use the cosmetics.

While the invention has been shown and described with reference to certain preferred embodiments thereof, it will be understood by those skilled in the art that various changes in form and details may be made thereto without departing from the spirit and scope of the invention as defined by the appended claims.

What is claimed is:

1. A case for cream cosmetics having an airless pump, the case comprising:
a storage case that stores the cream cosmetics in a storage space and has a push plate mounted therein;
an airtight cap that is sealingly engaged to an opening of the storage case and has therein a mount space and at one side an exit port communicating with the storage case;
a nozzle cap that is engaged to the storage case at an upper part of the airtight cap and has at one side a mount space in which a pump is mounted and at the other side a nozzle of a concave recess shape;
an airless pump that has a cylinder 41 vertically mounted between the airtight cap and the nozzle cap, a suction port having a suction valve is provided to a lower part of the cylinder, a discharge port having a discharge valve is provided to a side of an outer periphery so that the nozzle is connected to a discharge pipe, and a piston is provided in the pump to provide pumping force, the piston being moved upward and downward by an operation button and a spring; and
a cover that is openably engaged to an upper part of the nozzle cap.
